(19) United States
(12) Patent Application Publication
(10) Pub. No.: US 2026/0109092 A1
(43) Pub. Date: Apr. 23, 2026

(54) TRANSFERRING METHOD FOR IN-MOLD ROLLER PROCESS

(71) Applicant: ASUSTEK COMPUTER INC., TAIPEI (TW)

(72) Inventors: Jin-Ming WANG, TAIPEI (TW); Po-Wen HUANG, TAIPEI (TW); Yu-Chun YANG, TAIPEI (TW); Guo-Lin YANG, TAIPEI (TW); Er-Bao NIU, TAIPEI (TW)

(21) Appl. No.: 18/983,908

(22) Filed: Dec. 17, 2024

(30) Foreign Application Priority Data
Oct. 18, 2024 (TW) 113139738

(51) Int. Cl. B29C 45/16; B41C 1/10; B41M 1/30; B41M 3/12; B41N 1/16; B44C 1/24; C09D 11/107

(52) U.S. Cl. CPC B29C 45/1679; B41C 1/1008; B41M 1/305; B41M 3/12; B41N 1/16; B44C 1/24; C09D 11/107

(57) ABSTRACT

A transferring method for an in-mold roller process is provided. The transferring method includes the following steps. A plastic film is provided. A transfer ink and a printing roller are provided. A 3D pattern is formed on a surface of the printing roller. An ink pattern is formed on the plastic film by using the printing roller and the transfer ink, so as to form a transfer film. The transfer film is placed and positioned in a mold. The mold is filled with a structural material to form a structural member and cause the ink pattern to be transferred from the plastic film to a surface of the structural member. Finally, a solidification treatment is performed on the ink pattern.

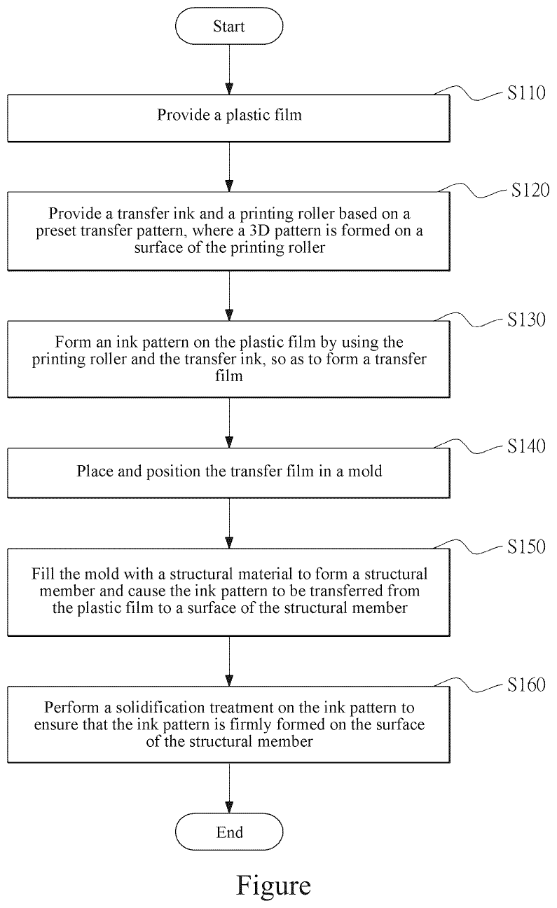

### CROSS-REFERENCE TO RELATED APPLICATION

This application claims the priority benefit of Taiwan Application Serial No. 113139738, filed on Oct. 18, 2024. The entirety of the above-mentioned patent application is hereby incorporated by reference herein and made a part of specification.

### BACKGROUND OF THE INVENTION

### Field of the Invention

The disclosure relates to a transferring method, and in particular, to a transferring method for an in-mold roller process.

### Description of the Related Art

In order to form decorative patterns on a product surface, a common surface treatment technology is forming decorative patterns on a product surface by using a transfer film. Depending on different positions in which the film is placed, the surface treatment technology is divided into in-mold roller (IMR) and out-mold roller (OMR).

The conventional in-mold roller process is prone to a problem of an inaccurate transfer pattern position, and it is impossible to accurately form a plurality of patterns of different colors on the product surface by using a single process. Therefore, the disclosure provides a transferring method to correct shortcomings of the conventional in-mold roller technology.

### BRIEF SUMMARY OF THE INVENTION

The disclosure provides a transferring method for an in-mold roller process. The transferring method includes the following steps. A plastic film is provided. A transfer ink and a printing roller are provided. A 3D pattern is formed on a surface of the printing roller. The transfer ink is transferred to the plastic film by using the printing roller, so as to form an ink pattern on the plastic film. The transfer film is placed and positioned in a mold. The mold is filled with a structural material to form a structural member and cause the ink pattern to be transferred from the plastic film to a surface of the structural member. Finally, a solidification treatment is performed on the ink pattern.

Compared with the conventional in-mold roller technology, the disclosure has the following advantages.

By using the printing roller and positioning technology provided in the disclosure, the transferring method provided in the disclosure is enabled to accurately specify on a surface of an object regions on which different colors are to be presented, a region on which a designed pattern is to be presented, and a position of a mark of regulations. Further, according to the transferring method provided in the disclosure, the regions where a plurality of colors is presented are simultaneously positioned, so as to achieve the effect of presenting the design patterns and the mark of regulations in different regions. In an embodiment, according to the transferring method provided in the disclosure, a seamless color jump on a keyboard of a notebook computer is achieved by using a single transferring process without using two or more process technologies.

A positioning device used in the transferring method of the disclosure automatically identifies a color and a pattern of a transfer film by using digits in place of a digital command technology, so as to accurately locate the transfer film. This is the ability that a conventional alignment device does not have.

In addition, the transfer ink used in the transferring method of the disclosure has advantages such as environmental protection and excellent physical functions, including abrasion resistance, impact resistance, high temperature resistance, sub-zero temperature resistance, stain resistance, and fingerprint resistance on a surface of an ink pattern film layer. Furthermore, a raw material of the ink used in the disclosure has a high solid content, which is beneficial to emission of volatile organic gases in the manufacturing process and meets requirements of environmental protection.

### BRIEF DESCRIPTION OF THE DRAWINGS

FIGURE is a flowchart of a transferring method for an in-mold roller process according to an embodiment of the disclosure.

### DETAILED DESCRIPTION OF THE EMBODIMENTS

Specific embodiments of the disclosure are described in more details below with reference to the schematic diagrams. Advantages and features of the disclosure are to be clearer based on the following descriptions and claims. It is to be noted that all the FIGURES are in a very simple form and in an inaccurate proportion, and are merely intended to assist description of the purpose of the embodiments of the disclosure conveniently and clearly.

FIGURE is a flowchart of a transferring method for an in-mold roller (IMR) process according to an embodiment of the disclosure.

As shown in the FIGURE, the transferring method provided in the disclosure includes the following steps.

In step S110, a plastic film is provided. The plastic film is a blank film.

In step S120, a transfer ink and a printing roller are provided based on a preset transfer pattern. A 3D pattern is formed on a surface of the printing roller.

In an embodiment, ingredients of the transfer ink include a modified acrylic copolymer, a polymer-monomer mixture, and a hydroxyl compound. The polymer-monomer mixture is helpful to improve characteristics such as high temperature resistance, freeze protection, and fingerprint resistance. The hydroxyl compound is helpful to improve characteristics such as oil resistance, toughness, aging resistance, and adhesiveness. In an embodiment, the transfer ink used in the disclosure includes 38 wt %-43 wt % of the modified acrylic copolymer, 7 wt %-13 wt % of the polymer-monomer mixture, 20 wt %-30 wt % of the hydroxyl compound, solvents, and additives, and is formed through a mixed chemical synthesis reaction.

In an embodiment, step S120 is forming a 3D pattern on the surface of the printing roller by photolithography.

Specifically, in step S120, pattern features such as a size, a color, and texture of a preset transfer pattern need to be determined first, so as to provide the transfer ink and the printing roller accordingly. In an embodiment, the printing roller is matched with the transfer ink of a plurality of colors for simultaneous printing.

In step S130, an ink pattern is formed on the plastic film by using the printing roller and the transfer ink, so as to form a transfer film. The ink pattern corresponds to the 3D pattern on the printing roller.

In an embodiment, before the ink pattern is formed on the plastic film by using the printing roller, the plastic film is deeply cleaned, and surface treatment is performed to enhance surface tension thereof, so as to help attach the transfer ink to the plastic film. In an embodiment, the surface tension of the plastic film is improved by corona discharge and surface coating. Further, in an embodiment, an anti-oxidation and dust-proof functional film layer is formed on the surface of the plastic film through the foregoing surface treatment, which is convenient for subsequent application.

The transfer ink is applied to the printing roller based on the design, and then transferred to the plastic film through the printing roller, to form a transfer film with an ink pattern formed on a surface thereof.

In step S140, the transfer film is placed and positioned in a mold. Specifically, in the step, the transfer film is placed and positioned in the mold with the plastic film facing outward (that is, directly contacting the mold) and the ink pattern facing inward.

In an embodiment, in the foregoing step of placing and positioning the transfer film in the mold, the transfer film is positioned in the mold by using an infrared aligner. The infrared aligner achieves a positioning effect by comparing a positioning marks on the transfer film with a positioning marks on the mold.

Further, in an embodiment, in the foregoing step of placing and positioning the transfer film in the mold, the transfer film is positioned in the mold by using a machine vision alignment system. The machine vision alignment system identifies a color and a pattern of the ink pattern on the transfer film to confirm an actual position of the transfer film, and then calculates an offset value between a current position and a target position of the transfer film to facilitate alignment adjustment.

In step S150, the mold is filled with a structural material to form a structural member and cause the ink pattern to be transferred from the plastic film to a surface of the structural member.

In an embodiment, the foregoing structural material is a plastic material. The step of filling the mold with the structural material to form the structural member is filling the mold with the structural material by injection molding to form the structural member.

Finally, in step S160, a solidification treatment is performed on the ink pattern to ensure that the ink pattern is firmly formed on the surface of the structural member. In an embodiment, the solidification treatment is a light solidification treatment. Specifically, the 3D transfer ink contains photosensitive resin. The foregoing solidification treatment irradiates the surface of the structural member with blue light, purple light, or ultraviolet light to solidify the ink pattern. However, the disclosure is not limited thereto. In another embodiment, the solidification treatment is alternatively a heat solidification treatment.

In an embodiment, the foregoing plastic film is adhered to the surface of the structural member, to provide an effect of protecting the ink pattern. However, the disclosure is not limited thereto. In another embodiment, after the solidification treatment is performed on the ink pattern, the plastic film is removed from the structural member to highlight the ink pattern and surface texture of the structural member.

Compared with the conventional in-mold roller technology, the disclosure has the following advantages.

By using the printing roller and positioning technology provided in the disclosure, the transferring method provided in the disclosure is enabled to accurately specify on a surface of an object regions on which different colors are to be presented, a region on which a designed pattern is to be presented, and a position of a mark of regulations. Further, according to the transferring method provided in the disclosure, the regions where a plurality of colors is presented are simultaneously positioned, so as to achieve the effect of presenting the design patterns and the mark of regulations in different regions. In an embodiment, according to the transferring method provided in the disclosure, a seamless color jump on a keyboard of a notebook computer is achieved by using a single transferring process without using two or more process technologies.

A positioning device used in the transferring method of the disclosure automatically identifies a color and a pattern of a transfer film by using digits in place of a digital command technology, so as to accurately locate the transfer film. This is the ability that a conventional alignment device does not have.

In addition, the transfer ink used in the transferring method of the disclosure has advantages such as environmental protection and excellent physical functions, including abrasion resistance, impact resistance, high temperature resistance, sub-zero temperature resistance, stain resistance, and fingerprint resistance on a surface of an ink pattern film layer. Furthermore, a raw material of the ink used in the disclosure has a high solid content, which is beneficial to emission of volatile organic gases in the manufacturing process and meets requirements of environmental protection.

The above descriptions are merely preferred embodiments of the disclosure, and do not impose any limitation on the disclosure. Any form of change such as an equivalent replacement or modification made by any person skilled in the art to technical means and technical content disclosed in the disclosure without departing from scope of the technical means of the disclosure is content that does not deviate from the technical means of the disclosure, and still falls within protection scope of the disclosure.

What is claimed is:

1. A transferring method for an in-mold roller (IMR) process, comprising:
providing a plastic film;
providing a transfer ink and a printing roller, wherein a 3D pattern is formed on a surface of the printing roller;
forming an ink pattern on the plastic film by using the printing roller and the transfer ink, so as to form a transfer film;
placing and positioning the transfer film in a mold;
filling the mold with a structural material to form a structural member, and causing the ink pattern to be transferred from the plastic film to a surface of the structural member; and
performing a solidification treatment on the ink pattern.

2. The transferring method according to claim 1, wherein the step of placing and positioning the transfer film in the mold comprises: positioning the transfer film in the mold by using an infrared aligner.

3. The transferring method according to claim 1, wherein the 3D pattern is formed on the surface of the printing roller by photolithography.

4. The transferring method according to claim 1, wherein ingredients of the transfer ink comprise a modified acrylic copolymer, a polymer-monomer mixture, and a hydroxyl compound.

5. The transferring method according to claim 4, wherein the transfer ink comprises 38 wt %-43 wt % of the modified acrylic copolymer, 7 wt %-13 wt % of the polymer-monomer mixture, and 20 wt %-30 wt % of the hydroxyl compound.

6. The transferring method according to claim 1, wherein the solidification treatment is a light solidification treatment.

7. The transferring method according to claim 1, wherein the structural material is a plastic material.

8. The transferring method according to claim 1, wherein the step of filling the mold with the structural material to form the structural member is filling the mold with the structural material by injection molding to form the structural member.

9. The transferring method according to claim 1, further comprising removing the plastic film from the structural member.
